(19) United States
(12) Patent Application Publication
(10) Pub. No.: US 2025/0059038 A1
(43) Pub. Date: Feb. 20, 2025

(54) PROCESS FOR THE PREPARATION OF SOLID SULFIDE MATERIAL OF FORMULA MALIBPCSDXE (I)

(71) Applicant: SPECIALTY OPERATIONS FRANCE, Lyon (FR)

(72) Inventors: Laure Bertry, Aubervilliers (FR); Lauriane D'Alencon, Issy-Les-Moulineaux (FR); Marc-David Braida, Bry-sur-Marne (FR)

(73) Assignee: SPECIALTY OPERATIONS FRANCE, Lyon (FR)

(21) Appl. No.: 18/721,109

(22) PCT Filed: Dec. 15, 2022
(86) PCT No.: PCT/EP2022/086150

§ 371 Date: Jun. 17, 2024

(30) Foreign Application Priority Data
Dec. 16, 2021 (EP) 21306792.9

(51) Int. Cl. C01B 17/22; H01M 10/0525; H01M 10/0562; H01M 50/409

(52) U.S. Cl. CPC C01B 17/22; H01M 10/0525; H01M 10/0562; H01M 50/409

(57) ABSTRACT

The present invention concerns a new process for the preparation of a solid sulfide material of formula (I): MₐLi_{b}P_{c}S_{d}Xₑ (I), wherein:—X represents at least one halogen clement:—a, b, c, d and e are real numbers;—a represents a number such as 0≤a<9;—b represents a number such as 0<b≤9;—2.0≤a+b≤9;—c represents a number such as 1.0≤c≤3.0;—d represents a number such as 1.0≤d≤11.0;—e represents a number such as 0<c≤3.0;—M is an alkali metal selected from Na, K, Rb, Cs and Fr; as well as the products obtainable by said process, and uses thereof especially as solid electrolytes.

This application claims priority to European patent application No. 21306792.9 filed on Dec. 16, 2021, the whole content of this application being incorporated herein by reference for all purposes.

The present invention concerns a new process for the preparation of a solid sulfide material of formula (I):

MₐLi_{b}P_{c}S_{d}Xₑ (I),

wherein:
X represents at least one halogen element;
a, b, c, d and e are real numbers;
a represents a number such as 0≤a<9;
b represents a number such as 0<b≤9;
2.0≤a+b≤9;
c represents a number such as 1.0≤c≤3.0;
d represents a number such as 1.0≤d≤11.0;
e represents a number such as 0<e≤3.0; and
M is an alkali metal selected from Na, K, Rb, Cs and Fr;
as well as the products obtainable by said process, and uses thereof especially as solid electrolytes.

### PRIOR ART

Lithium batteries are used to power portable electronics and electric vehicles owing to their high energy and power density. Conventional lithium batteries make use of a liquid electrolyte that is composed of a lithium salt dissolved in an organic solvent. The aforementioned system raises security questions as the organic solvents are flammable. Lithium dendrites forming and passing through the liquid electrolyte medium can cause short circuits and produce heat, which result in accidents that lead to serious injuries.

Non-flammable inorganic solid electrolytes offer a solution to the security problem. Furthermore, their mechanical stability helps suppressing lithium dendrite formation, preventing self-discharge and heating problems, and prolonging the life-time of a battery.

Solid sulfide electrolytes are advantageous for lithium battery applications due to their high ionic conductivities and mechanical properties. These electrolytes can be pelletized and attached to electrode materials by cold pressing, which eliminates the necessity of a high temperature assembly step. Elimination of the high temperature sintering step removes one of the challenges against using lithium metal anodes in lithium batteries.

A difficulty experienced with the solid sulfide electrolytes is that hydrogen sulfide (H₂S) is released when the material is in contact with humidity. Hydrogen sulfide has a pungent odor and is toxic; there is therefore a need for a solid sulfide electrolyte having enhanced chemical stability which releases a low quantity of H₂S.

Solid sulfides as reported in the literature, are generally prepared via high-temperature solid-state synthesis, or via dry or wet mechanochemical routes. All solution routes are also proposed such as methods starting from pre-formed solid sulfides dissolved in a solvent such as ethanol. There is thus a need for new solid sulfide electrolytes and for new process to prepare solid sulfide electrolytes.

J. Chen et al. in Chem. Lett. 2019, 48, 863-865 have shown that synthesis of Li₂NaPS₄ was achievable through Na⁺/Li⁺ ion-exchange from Na₃PS₄. However, the authors are silent about similar approach involving sulfide materials comprising halogens. Moreover, nothing is said about the effect of this ion-exchange onto the ionic conductivity of the resulting sulfide materials and nothing is said about the chemical stability of the resulting materials.

There still exists a need for new routes for the preparation of a solid sulfide material that can be used for the manufacture of sulfide-based solid electrolyte having enhanced ionic conductivity.

There is also a need for new routes for the preparation of solid sulfide material which can spare or even suppress the use of lithium sulfide, Li₂S. Indeed, Li₂S, is a costly raw material, difficult to prepare, to purify, to handle and for these reasons, not industrially available, a fortiori in high purity grades.

There is also a need for new routes for the preparation of solid sulfide material which has good chemical stability and which gives low emission of H₂S when exposed e.g to humid air.

### INVENTION

The present invention concerns a new process for the preparation of a solid sulfide material (A) of formula MₐLi_{b}P_{c}S_{d}Xₑ (I).

The invention also relates to solid sulfide material (A) of formula MₐLi_{b}P_{c}S_{d}Xₑ (I), susceptible to be obtained by the process of the invention. The invention also relates to the use of such solid sulfide material (A) as solid electrolyte. The present invention also refers to a solid electrolyte comprising such solid sulfide material (A) and an electrochemical device comprising a solid sulfide material (A) according to the invention. The invention also relates to a solid state battery comprising a solid electrolyte of the invention and a vehicle comprising a solid state battery.

The inventors have found that surprisingly the solid sulfide materials prepared by the process according to the invention have enhanced ionic conductivity when compared to solid sulfide materials having similar composition but prepared by conventional ways mentioned above such as high-temperature solid-state synthesis or mechanochemical routes. Indeed, in the process according to the invention, replacing Na⁺ by Li⁺ in a Na⁺ based starting material appears to be responsible for the high Li⁺ mobility within the resulting solid sulfide material.

The inventors have also found that the new process according to the invention allows advantageously to prepare solid sulfide material having high ionic conductivity, while sparing the use of lithium sulfide, Li₂S, which is an expensive raw material difficult to obtain in large quantities especially in high purity grades.

### DETAILED INVENTION

Thus the present invention relates to a process for preparing a solid sulfide material (A) of formula (I):

MₐLi_{b}P_{c}S_{d}Xₑ (I)

wherein:
X represents at least one halogen element;
a, b, c, d and e are real numbers;
a represents a number such as 0≤a<9;
b represents a number such as 0<b≤9;
2.0≤a+b≤9;
c represents a number such as 1.0≤c≤3.0;
d represents a number such as 1.0≤d≤11.0;
e represents a number such as 0<e≤3.0;
M is an alkali metal selected from Na, K, Rb, Cs and Fr; comprising the steps of
(i) stirring a mixture (M1) comprising a starting material (B) of formula (II):

Mₐ₁Li_{b1}P_{c1}S_{d1}Xₑ₁ (II)

wherein:
M is an alkali metal selected from Na, K, Rb, Cs and Fr;
X represents at least one halogen element;
a1, b1, c1, d1 and e1 are real numbers;
a1 represents a number such as 0<a1≤9 and a<a1;
b1 represents a number such as 0≤b1≤6.0 and b1<b;
2.0≤a1+b1≤9;
c1 represents a number such as 1.0≤c1≤3.0;
d1 represents a number such as 1.0≤d1≤11.0;
e1 represents a number such as 0<e1≤3.0;
   at least one lithium compound LiY, wherein Y is a counter anion, and a solvent (S) so as to promote the reaction of the starting material (B) with the lithium compound LiY that produces the solid sulfide material (A) and at least 20 one metal compound MY;
(ii) obtaining a mixture (M2) comprising the solid sulfide material (A), the metal compound MY, optionally unreacted lithium compound LiY and the solvent (S);
(iii) recovering the solid sulfide material (A) from the mixture (M2);
(iv) optionally submitting the solid sulfide material (A) recovered in step (iii) to a thermal treatment.

Without being bound to any theory, the process is assumed to be a cationic exchange between an at least one lithium compound LiY and a starting material (B) of formula

Mₐ₁Li_{b1}P_{c1}S_{d1}Xₑ₁ (II).

Accordingly, the overall reaction which is assumed to occur during the process can be expressed as follows:

Mₐ₁Li_{b1}P_{c1}S_{d1}Xₑ₁ (II)+αLiY→MₐLi_{b}P_{c}S_{d}Zₑ(I)+αMY
wherein M, X, Y, a1, a, b1, b, c1, c, d1, d, e1 and e are as previously defined, and
wherein a= (a1−α) and b=(b1+α) and α≤a1

It is assumed that the most labile Na+ sites are substituted by Li+ during the process according to the invention, while the less labile Na+sites keep the structure morphology of the starting material. It is also assumed that since Li+ ionic radius is smaller than Na+ ionic radius an improved mobility and thus an improved ionic conductivity is observed for the resulting solid sulfide material (A).

M is an alkali metal selected from Na, K, Rb, Cs and Fr. Preferably M is Na. X is selected from Br, Cl, I and mixtures thereof. Preferably X is selected from Br, Cl and mixtures thereof, more preferably X is Cl. In some embodiments M is Na and X is Cl; in some other embodiments M is Na and X is Br; still in some other embodiments M is Na and X is Cl and Br. When X is Cl and Br, the molar ratio Cl/Br generally ranges from 0.01 to 100.

In the process according to the invention the starting material (B) is generally of formula (II) as follows:

Mₐ₁Li_{b1}P_{c1}Xₑ₁ (II)
wherein M, X, a1, b1, c1, d1 and e1 are as previously defined and the solid sulfide material (A) prepared by the process according to the invention is of formula (I)

MₐLi_{b}P_{c}S_{d}Xₑ (I)
wherein M, X, a, b, c, d and e are as previously defined.

Besides, the starting material (B) of formula Mₐ₁Li_{b1}P_{c1}S_{d1}Xₑ₁ (II) can be prepared by conventional methods described in the patent and non-patent literature.

In some embodiments the starting material (B) is a crystalline solid sulfide compound comprising Na, P, S and optionally Li, wherein substituting X⁻ for S²⁻ is a strategy to obtain Na⁺ vacancies and/or Li⁺ vacancies when Li is present.

Accordingly, in some embodiments, the starting material (B) is of formula (IIa)

Na_{7-x-y}LiₓPS_{6-y}X_{y} (IIa)
wherein 0≤x<7−y and 0<y≤3 and the solid sulfide material (A) prepared by the process according to the invention is of formula (Ia)

Na_{7-x-y}Liₓ₁PS_{6-y}X_{y} (Ia)
wherein 0<x1<7−y, x1>x and 0<y≤3; and
wherein X represents at least one halogen element.

For the solid sulfide (B) of formula (IIa) and the solid sulfide material (A) of formula (Ia), X is selected from Br, Cl, I and mixtures thereof. Preferably X is selected from Br, Cl and mixtures thereof, more preferably X is Cl. When X is Cl and Br, the molar ratio Cl/Br generally ranges from 0.01 to 100.

The solid sulfide (B) of formula (IIa) can be prepared by any method well known by the person having ordinary skill in the art. Sodium sulfide (Na₂S), lithium sulfide (Li₂S), phosphorous pentasulfide (P₂S₅), Lithium halide (LiX) and sodium halide (NaX) are generally used as the raw materials with the convenient stoichiometry in order to form the desired sulfide composition.

For the sake of example Na_{7-x-y}LiₓPS_{6-y}X_{y} can be prepared using the following stoichiometry: (7−x−2y) Na₂S; (x) Li₂S; 1 P₂S₅; 2y NaX.

NaX is generally selected from NaCl, NaBr, NaI and mixtures thereof. LiX is generally selected from LiCl, LiBr, LiI and mixtures thereof. Commercially available raw materials can be used. However, those having a high degree of purity are preferred. Raw materials are generally in the form of powders.

In some other embodiments the starting material (B) is a glass ceramic solid sulfide compound based on a binary Na₂S—P₂S₅ optionally tertiary Na₂S—Li₂S—P₂S₅ glassy material comprising Na, P, S and optionally Li, wherein an inorganic salt NaX and optionally LiX is added to increase sodium ion concentration optionally lithium ion concentration.

Accordingly, in some embodiments, the starting material (B) is a glass ceramic of formula (IIGa)

(1−p)[ 7/2[(1−q)Na₂S·qLi₂S]·½P₂S₅]·p[(1−r)NaX·rLiX] (IIGa)
wherein 0<p≤0.5, 0≤q<1 and 0≤r<1 and wherein X represents at least one halogen element.

Particularly, when q=r=0, the starting material (B) is a glass ceramic of formula (IIGa′)

(1−p)Na₇PS₆·pNaX (IIGa′)
wherein 0<p≤0.5 and X represents at least one halogen element.

More particularly, when q=r=0 and p=0.5, the starting material (B) is a glass ceramic of formula (IIGa″)

Na₈PS₆X (IIGa″)
wherein X represents at least one halogen element.

In some embodiments, the starting material (B) is a glass ceramic of formula (IIGb)

(1−p)[4[(1−q)Na₂S·qLi₂S]·1P₂S₅]·p[(1−r)NaX·rLiX] (IIGb)
wherein 0<p≤0.5, 0≤q<1 and 0≤r<1 and wherein X represents at least one halogen element.

Particularly, when q=r=0, the starting material (B) is a glass ceramic of formula (IIGb′)

(1−p)Na₈P₂S₉·pNaX (IIGb′)
wherein 0<p≤0.5 and X represents at least one halogen element. More particularly, when q=r=0 and p=0.5, the starting material (B) is a glass ceramic of formula (IIGb″)

Na₉P₂S₉X (IIGb″)
wherein X represents at least one halogen element.

In some other embodiments, the starting material (B) is a glass ceramic of formula (IIGc)

(1−p)[ 3/2[(1−q)Na₂S·qLi₂S]·½P₂S₅]·p[(1−r)NaX·rLiX] (IIGc)
wherein 0<p≤0.5, 0≤q<1 and 0≤r<1 and wherein X represents at least one halogen element.

Particularly, when q=r=0, the starting material (B) is a glass ceramic of formula (IIGc′)

(1−p)Na₆P₂S₈·pNaX (IIGc′)
wherein 0<p≤0.5 and X represents at least one halogen element.

More particularly, when q=r=0 and p=0.5, the starting material (B) is a glass ceramic of formula (IIGc″)

Na₇P₂S₈X (IIGc″)
wherein X represents at least one halogen element.

Still more particularly, when q=r=0 and p=2/3, the starting material (B) is a glass ceramic of formula (IIGc″)

Na₄PS₄X (IIGc″)
wherein X represents at least one halogen element.

Still in some other embodiments, the starting material (B) is a glass ceramic of formula (IIGd)

(1−p) [ 7/2[(1−q)Na₂·qLi₂S]· 3/2P₂S₅]·p[(1−r)NaX·rLiX] (IIGd)
wherein 0<p≤0.5, 0≤q<1 and 0≤r<1 and wherein X represents at least one halogen element.

Particularly, when q=r=0, the starting material (B) is a glass ceramic of formula (IIGd′)

(1−p)Na₇P₃S₁₁·pNaX (IIGd″)
wherein 0<p≤0.5 and X represents at least one halogen element.

More particularly, when q=r=0 and p=0.5, the starting material (B) is a glass ceramic of formula (IIGd″)

Na₈P₃S₁₁X (IIGd″)
wherein X represents at least one halogen element.

In some other embodiments, the starting material (B) is a glass ceramic of formula (IIGe)

(1−p)[1[(1−q)Na₂S·qLi₂S]·1P₂S₅]·p [(1−r)NaX·rLiX] (IIGe)
wherein 0<p≤0.5, 0≤q<1 and 0≤r<1 and wherein X represents at least one halogen element.

Particularly, when q=r=0, the starting material (B) is a glass ceramic of formula (IIGe′)

(1−p)Na₂P₂S₆·pNaX (IIGe′)
wherein 0<p≤0.5 and X represents at least one halogen element. More particularly, when q=r=0 and p=0.5, the starting material (B) is a glass ceramic of formula (IIGe″)

Na₃P₂S₆X (IIGe″)
wherein X represents at least one halogen element.

The glass ceramics of formulae (IIGa) to (IIGe), (IIGa′) to (IIGe′), (IIGa″) to (IIGe″) and (IIGc″) as above described can be prepared by any method well known by the person having ordinary skill in the art. Na₂S, Li₂S, P₂S₅, NaX and LiX are used as the raw materials in the convenient stoichiometry to form the desired composition. NaX is generally selected from NaCl, NaBr, NaI and mixtures thereof. LiX is generally selected from LiCl, LiBr, LiI and mixtures thereof. Commercially available raw materials can be used. However, those having a high degree of purity are preferred. Raw materials are generally in the form of powders.

Just for the sake of example, solid sulfide compounds of formulae (IIa), (IIGa) to (IIGe), (IIGa′) to (IIGe′), (IIGa″) to (IIGe″) and (IIGc″″) can be prepared by well-known mechanochemical techniques wherein a reaction can be induced by mechanical treatment or mechanical milling.

The reaction by mechanical milling can be performed using various types of well-known mechanical milling equipment such as planetary ball mill.

The rotation speed and rotation time of mechanical milling are not particularly limited, but the higher the rotation speed, the faster the generation rate of solid sulfide, and the longer the rotation time, the higher the conversion rate of the starting material to desired sulfide. Mechanical treatment can be carried out for 1 to 130 hours.

Mechanical treatment can be performed in the presence of a liquid (e.g. wet ball-milling). Suitable liquid is generally a liquid hydrocarbon. The liquid hydrocarbon is often selected in the group consisting of aliphatic hydrocarbons, cycloaliphatic hydrocarbons, aromatic hydrocarbons and mixtures thereof. Aliphatic hydrocarbons are for instance hexane, heptane, octane or nonane. Cycloaliphatic hydrocarbons are for instance cyclohexane, cyclopentane or cycloheptane. Aromatic hydrocarbons are for instance benzene, toluene, ethylbenzene, xylenes or liquid naphthenes. A convenient liquid hydrocarbon that can be used is xylene.

Mechanical treatment can be performed under an inert atmosphere such as argon, nitrogen or mixture thereof.

Generally mechanical treatment is carried out at room temperature (about 25° C.) but may be carried out at higher temperature.

After mechanical treatment the resulting mixture is generally calcined at a temperature ranging from 150° C. to 600° C. Calcination is generally performed under an inert atmosphere, for instance under an atmosphere of N₂ or Ar or H₂S. The duration of step calcination is generally between 1 and 12 hours. Calcination can be performed e.g. in a rotative oven.

After cooling, the solid sulfide can be recovered as granules that can be further sieved or grinded to reach desired particles size.

Calcination is generally performed with a mixture having been previously dried. This may be performed by using already dried starting materials or by drying the mixture. When wet-ball milling is used, drying may also be easily and conveniently performed through the evaporation of the liquid hydrocarbon. The evaporation of the liquid hydrocarbon is preferably performed at a temperature between 100° C. and 150° C. The evaporation may be performed under vacuum. The duration of the evaporation is generally between 1 and 20 hours.

Solid sulfide (B) of formula (IIa) can also be prepared by solution process for example as described in Journal of Power Sources 293 (2015) 941-945.

Sulfides glass can be prepared by well-known mechanochemical techniques wherein a reaction can be induced by mechanical treatment or mechanical milling. For example such a technique is described in Solid State Ionics 270 (2015) 6-9 for the synthesis of Na₃PS₄—NaI glass ceramics.

Glass ceramics can also be prepared by solution process, for example as described in Journal of Alloys and Compounds 798 (2019) 235-242, or by suspension process, for example as described in Nature Reviews Chemistry, volume 3, pages 189-198 (2019).

The present invention relates to a new process for the preparation of solid sulfide material having improved ionic conductivity.

As already mentioned, the overall reaction which occurs during the process can be expressed as follows:

Mₐ₁Li_{b1}P_{c1}S_{d1}Xₑ₁ (II)+αLiY→MₐLi_{b}P_{c}S_{d}Xₑ (I)+αMY

wherein M, X, Y, a1, a, b1, b, c1, c, d1, d, e1 and e are as previously defined,
and
wherein α=(α1−α) and b=(b1+α) and α≤α1.

The lithium compound LiY is generally selected from the list consisting of lithium triflate, lithium 4,5-dicyano-2-(trifluoromethyl)imidazole, lithium hexafluorophosphate, lithium bis(oxalato)borate, lithium bis(fluorosulfonyl)amide (LiFSA), Lithium bis(fluorosulfonyl)imide (LiFSI), lithium bis(trifluoromethanesulfonyl)imide (LiTFSI), lithium acetate, lithium carbonate, lithium citrate, lithium nitrate, lithium chloride, lithium bromide, lithium oxalate, lithium iodide, lithium fluoride, lithium methyl carbonate, lithium ethyl carbonate, lithium methoxide and mixtures thereof. The Y counter anion is then respectively selected from triflate, 4,5-dicyano-2-(trifluoromethyl)imidazolate, hexafluorophosphate, bis(oxalato)borate, bis(fluorosulfonyl)amide anion, bis(fluorosulfonyl)imide anion, bis(trifluoromethanesulfonyl)imide anion, acetate, carbonate, citrate, nitrate, chloride, bromide, oxalate, iodide, fluoride, methyl carbonate, ethyl carbonate, methoxide and mixtures thereof.

In some embodiments, the lithium compound LiY is lithium bis(fluorosulfonyl)amide (LiFSA). In some other embodiments, the lithium compound LiY is lithium bis(trifluoromethanesulfonyl)imide (LiTFSI).

In some other embodiments, the lithium compound LiY is lithium chloride, lithium bromide or a mixture thereof. Still in some other embodiments, the lithium compound LiY is lithium nitrate.

Generally, the starting material (B) and the lithium compound LiY are in the powder form. Before use, said powder can be milled e.g. using a Zirconium mortar and pestle, or planetary ball milling, or similar milling tools to obtain desired particles size.

Generally the molar ratio LiY/B of the lithium compound LiY over the starting material (B) in the mixture (M1) ranges from 1 to 20, often LiY/B ranges from 2 to 7.

The solvent (S) is generally selected from the list consisting of acetonitrile, adiponitrile, glutaronitrile, acetone, ethyl acetate, ethyl propionate, diethyl ether, dimethyl carbonate, diethyl carbonate, ethyl methyl carbonate, fluoroethylene carbonate, ethylene carbonate, propylene carbonate, vinylene carbonate, DMF, NMP, DMSO, tetra(ethylene glycol) dimethyl ether, triethylene glycol dimethyl ether, diethylene glycol dimethyl ether, ethylene glycol dimethyl ether, tetrahydrofuran and mixtures thereof.

In some embodiments, the solvent (S) is acetonitrile. In some other embodiments, the solvent (S) is ethylene carbonate. In some other embodiments, the solvent (S) is propylene carbonate. Still in some other embodiments, the solvent (S) is dimethyl carbonate.

Generally the solvent (S) is anhydrous. By anhydrous is meant that the solvent (S) contains less than 0.1 weight % of water, often less than 0.01 weight %, sometimes less than 0.001 weight %.

In some embodiments, the lithium compound LiY is lithium bis(fluorosulfonyl)amide (LiFSA) and the solvent (S) is acetonitrile.

In some other embodiments, the lithium compound LiY is lithium bis(trifluoromethanesulfonyl)imide (LiTFSI) and the solvent( S) is acetonitrile.

Still in some other embodiments, the lithium compound LiY is lithium bis(trifluoromethanesulfonyl)imide (LiTFSI) and the solvent (S) is propylene carbonate.

Generally the weight ratio S/(B+LiY) of the weight of the solvent (S) over the weight of the lithium compound LiY and of the starting material (B) ranges from 1 to 50, often from 2 to 25, sometimes from 5 to 10.

The components (A), (B), LiY and MY comprised in the mixtures (M1) and (M2) can have different solubility behavior in the solvent (S).

In some embodiments the lithium compound LiY is partially solubilized in the solvent (S). By partially solubilized in the solvent (S) is meant that at least 1% by weight and no more than 99% by weight of the lithium compound LiY is solubilized in the solvent (S).

In some other embodiments the lithium compound LiY is completely solubilized in the solvent (S).

In some embodiments the metal compound MY is partially solubilized in the solvent (S). By partially solubilized in the solvent (S) is meant that at least 1% by weight and no more than 99% by weight of the metal compound is solubilized in the solvent (S).

In some other embodiments the metal compound MY is completely solubilized in the solvent (S).

In some embodiments the lithium compound LiY and the metal compound MY are partially solubilized in the solvent (S).

In some other embodiments the lithium compound LiY is partially solubilized in the solvent (S) and the metal compound MY is completely solubilized in the solvent (S).

Still in some other embodiments the lithium compound LiY and the metal compound MY are completely solubilized in the solvent (S).

The starting material (B) is generally not solubilized in the solvent (S). Often the starting material (B) is suspended in the solvent (S). In some embodiments, the starting material (B) is swollen by the solvent (S).

In some embodiments, the starting material (B) is suspended in the solvent (S) while the lithium compound LiY is partially solubilized.

In some embodiments, the starting material (B) is suspended in the solvent (S) while the lithium compound LiY is completely solubilized.

The solid material (A) is generally not solubilized in the solvent (S). Often the solid material (A) is suspended in the solvent (S). In some embodiments, the solid material (A) is swollen by the solvent (S).

In some embodiments, the solid material (A) is suspended in the solvent (S) while the lithium compound LiY and the metal compound MY are partially solubilized.

In some embodiments, the solid material (A) is suspended in the solvent (S) while the lithium compound LiY and the metal compound MY are completely solubilized.

In some embodiments, the starting material (B) and the solid material (A) are suspended in the solvent (S) while the lithium compound LiY and the metal compound MY are partially solubilized in the same.

In some other embodiments, the starting material (B) and the solid material (A) are suspended in the solvent (S) while the lithium compound LiY and the metal compound MY are completely solubilized.

Still in some other embodiments, the starting material (B) and the solid material (A) are suspended in the solvent (S) while the lithium compound LiY and the metal compound MY are at least partially solubilized in the same. By at least partially solubilized is meant that LiY and MY, can be simultaneously or not, completely solubilized in the solvent (S).

Generally, the starting material (B) and the lithium compound LiY are in the powder form. Before use, said powder can be milled e.g. using a Zirconium mortar and pestle, or planetary ball milling, or similar milling tools to obtain desired particles size.

In some embodiments, the lithium compound LiY is partially solubilized or completely solubilized in the solvent (S) before the powder of starting material (B) is added to form the mixture (M1).

In some other embodiments, the powder of lithium compound LiY and the powder of the starting material (B) are simultaneously or successively added to the solvent (S) to form the mixture (M1).

Step (i) of the process according to the invention consists in stirring a mixture (M1) comprising a starting material (B) at least one lithium compound LiY, wherein Y is a counter anion, and a solvent (S) so as to promote the reaction of the starting material (B) with the lithium compound LiY that produces the solid sulfide material (A) and at least one metal compound MY.

Stirring of the mixture (M1) is generally performed by any mean well known by the person having ordinary skill in the art.

Generally stirring is performed at a temperature ranging from 15° C. to 70° C. Often stirring is performed at a temperature ranging from 15° C. to 40° C. Typically stirring is performed at a temperature ranging from 20° C. to 30° C.

The reaction of the starting material (B) with the lithium compound LiY is sometimes conducted until complete reaction of the starting material (B) to produce the solid sulfide material (A).

The mixture (M2) obtained in step (ii) comprises the solid sulfide material (A), the metal compound MY, optionally unreacted lithium compound LiY and the solvent (S).

In some embodiments, in the mixture (M2) the solid sulfide material (A) is suspended in the solvent (S) while the metal compound MY and optionally unreacted lithium compound LiY when present are partially solubilized in the solvent (S).

In some other embodiments, in the mixture (M2) the solid sulfide material (A) is suspended in the solvent (S) while the metal compound MY and optionally unreacted lithium compound LiY when present are completely solubilized in the solvent (S).

Still in some other embodiments, in the mixture (M2) the solid sulfide material (A) is suspended in the solvent (S) while the metal compound MY and optionally unreacted lithium compound LiY when present are at least partially solubilized in the solvent (S). By at least partially solubilized is meant that MY and LiY when present, can be, simultaneously or not, completely solubilized in the solvent (S).

In step (iii) the solid sulfide material (A) is recovered from the mixture (M2). Recovering can be made by centrifugation of the mixture (M2) to precipitate the suspended solid sulfide material (A), followed by elimination of the supernatant. The obtained solid sulfide material (A) can then be suspended in fresh solvent (S) e.g. under stirring and recovered by a new cycle of centrifugation/elimination of the supernatant. Several cycles may be needed to eliminate the metal compound MY and unreacted lithium compound LiY.

In some embodiments, the solid sulfide material (A) can be recovered by simple filtration of the mixture (M2) optionally followed by rinsing with fresh solvent (S) to eliminate the metal compound MY and unreacted lithium compound LiY.

In some embodiments, the recovered solid sulfide material (A) is submitted to several cycles comprising steps i) to iii).

The solid sulfide material (A) recovered in step (iii) is optionally further submitted to a thermal treatment in a step iv). Thermal treatment is generally performed at a temperature ranging from 50 to 550° C.

The thermal treatment of step iv) may comprise the evaporation of the solvent (S) remaining in the solid sulfide material (A) recovered in step (iii). The evaporation of the remaining solvent (S) is generally performed at a temperature ranging from 50° C. to 150° C. The evaporation may be performed under vacuum. The duration of the evaporation is generally between 1 and 20 hours, more particularly between 2 and 20 hours or between 3 and 7 hours. At the end of the evaporation, the solid sulfide material (A) may comprise some residual solvent (S). The amount of residual solvent is generally such that carbon content in the solid sulfide material (A) is below 2.0 wt. %. The carbon content may be between 0.01 and 1.0 wt. %.

The thermal treatment of step iv) may also comprise heat treatment at a temperature higher than 150° C. and up to 550° C.

In some embodiments the thermal treatment comprises evaporation of the remaining solvent (S) at a temperature ranging from 50° C. to 150° C. and heat treatment at a temperature higher than 150° C. and up to 550° C.

In some other embodiments the thermal treatment consists of evaporation of the remaining solvent (S) at a temperature ranging from 50° C. to 150° C.

Generally, the solid sulfide material (A) is recovered in the form of a powder that can be milled e.g. using a Zirconium mortar and pestle, or planetary ball milling, or similar milling tools to obtain desired particles size.

The invention also concerns a solid sulfide material (A) as previously defined prepared by the process according to the invention.

The invention also relates to the use of such solid sulfide material (A) as solid electrolyte.

The invention also concerns an electrochemical device comprising a solid electrolyte comprising at least a solid sulfide material (A) as previously defined prepared by the process according to the invention.

Preferably in the electrochemical device, particularly a rechargeable electrochemical device, the solid electrolyte is a component of a solid structure for an electrochemical device selected from the group consisting of cathode, anode and separator.

Herein preferably the solid electrolyte is a component of a solid structure for an electrochemical device, wherein the solid structure is selected from the group consisting of cathode, anode and separator. Accordingly, the solid sulfide material (A) prepared by the process according to the invention can be used alone or in combination with additional components for producing a solid structure for an electrochemical device, such as a cathode, an anode or a separator.

The electrode where during discharging a net negative charge occurs is called the anode and the electrode where during discharging a net positive charge occurs is called the cathode. The separator electronically separates a cathode and an anode from each other in an electrochemical device.

Suitable electrochemically active cathode materials and suitable electrochemically active anode materials are well known in the art. In an electrochemical device according to the invention, the anode preferably comprises graphitic carbon, metallic lithium, silicon compounds such as Si, SiOₓ, lithium titanates such as Li₄Ti₅O₁₂ or a metal alloy comprising lithium as the anode active material such as Sn.

In an electrochemical device according to the invention, the cathode preferably comprises a metal chalcogenide of formula LiMeQ₂, wherein Me is at least one metal selected from transition metals such as Co, Ni, Fe, Mn, Cr and V and Q is a chalcogen such as O or S. Among these, it is preferred to use a lithium-based composite metal oxide of formula LiMeO₂, wherein Me is the same as defined above. Preferred examples thereof may include LiCoO₂, LiNiO₂, LiNixCo₁₋ₓO₂ (0<x<1), and spinel-structured LiMn₂O₄ and LiMn_{1.5}Ni_{0.5}O₄. Another preferred examples thereof may include lithium-nickel-manganese-cobalt-based metal oxide of formula LiNiₓMn_{y}Co_{z}O₂ (x+y+z=1, referred to as NMC), for instance LiNi_{1/3}Mn_{1/3}Co_{1/3}O₂, LiNi_{0.6}Mn_{0.2}Co_{0.2}O₂, and lithium-nickel-cobalt-aluminum-based metal oxide of formula LiNiₓCo_{y}Al_{z}O₂ (x+y+z=1, referred to as NCA), for instance LiNi_{0.8}Co_{0.15}Al_{0.05}O₂. Cathode may comprise a lithiated or partially lithiated transition metal oxyanion-based material such as LiFePO₄.

For example, the electrochemical device has a cylindrical-like or a prismatic shape. The electrochemical device can include a housing that can be made from steel or aluminum or multilayered films polymer/metal foil.

A further aspect of the present invention refers to batteries, more preferably to an alkali metal battery, in particular to a lithium battery comprising at least one inventive electrochemical device, for example two or more. Electrochemical devices can be combined with one another in inventive alkali metal batteries, for example in series connection or in parallel connection.

The present invention also relates to a battery, preferably a lithium battery, comprising at least the solid sulfide material (A) obtainable by the process according to the invention.

The battery where the solid sulfide material (A) obtainable by the process according to the invention is used can be a lithium-ion or a lithium metal battery.

Typically, a lithium solid-state battery includes a positive electrode active material layer containing a positive electrode active material, a negative electrode active material layer containing a negative electrode active material, and a solid electrolyte layer formed between the positive electrode active material layer and the negative electrode active material layer. At least one of the positive electrode active material layer, the negative electrode active material layer, and the solid electrolyte layer includes a solid electrolyte as defined above.

The cathode of an all-solid state electrochemical device usually comprises a solid electrolyte in addition to an active cathode material. Similarly, the anode of an all-solid state electrochemical device typically includes a solid electrolyte in addition to an active anode material.

The form of the solid structure for an electrochemical device, in particular for an all-solid-state lithium battery, depends in particular on the form of the produced electrochemical device itself. The present invention further provides a solid structure for an electrochemical device wherein the solid structure is selected from the group consisting of cathode, anode and separator, wherein the solid structure for an electrochemical device comprises a solid sulfide material (A) obtainable by the process according the invention.

A plurality of electrochemical cells may be combined to an all solid-state battery, which has both solid electrodes and solid electrolytes.

The present invention also relates to an electrode comprising at least the solid sulfide material (A) obtainable by the process according to the invention.

The solid sulfide material (A) obtainable by the process according to the invention disclosed above may be used in the preparation of an electrode. The electrode may be a positive electrode or a negative electrode.

The electrode typically comprises at least:
a metal substrate;
a layer of a composition (C) in contact with the metal substrate, said composition (C) comprising:
(i) the solid sulfide material (A) obtainable by the process according to the invention;
(ii) at least one electroactive compound (EAC);
(iii) optionally at least one material which conducts the Li ions other than the solid sulfide material (A) obtainable by the process according to the invention;
(iv) optionally at least one electrically-conductive material (ECM);
(v) optionally a lithium salt (LIS);
(vi) optionally at least one polymer binder material (P).

The electro-active compound (EAC) denotes a compound which is able to incorporate or insert into its structure and to release lithium ions during the charging phase and the discharging phase of an electrochemical device. An EAC may be a compound which is able to intercale and deintercalate into its structure lithium ions. For a positive electrode, the EAC may be a composite metal chalcogenide of formula LiMeQ2 wherein:
Me is at least one metal selected in the group consisting of Co, Ni, Fe, Mn, Cr, Al and V;
Q is a chalcogen such as O or S.

The EAC may more particularly be of formula LiMeO₂. Preferred examples of EAC include LiCoO₂, LiNiO₂, LiMnO₂, LiNiₓCo₁₋ₓO₂ (0<x<1), LiNiₓCo_{y}Mn_{z}O₂ (0<x, y, z<1 and x+y+z=1) for instance LiNi_{1/3}Mn_{1/3}Co_{1/3}O₂, LiNi_{0.6}Mn_{0.2}Co_{0.2}O₂, LiNi_{0.8}Mn_{0.1}Co_{0.1}O₂, Li(NiₓCo_{y}Al_{z})O₂ (x+y+z=1) and spinel-structured LiMn₂O₄ and Li(Ni_{0.5}Mn_{1.5})O₄.

The EAC may also be a lithiated or partially lithiated transition metal oxyanion-based electro-active material of formula M₁M₂(JO₄)_{f}E_{1-f}, wherein:
M₁ is lithium, which may be partially substituted by another alkali metal representing less that 20% of M1;
M₂ is a transition metal at the oxidation level of +2 selected from Fe, Co, Mn, Ni or mixtures thereof, which may be partially substituted by one or more additional metals at oxidation levels between +1 and +5 and representing less than 35% of the M₂ metals, including 0;
JO₄ is any oxyanion wherein J is either P, S, V, Si, Nb, Mo or a combination thereof;
E is a fluoride, hydroxide or chloride anion;
f is the molar fraction of the JO₄ oxyanion, generally comprised between 0.75 and 1.

The M₁M₂(JO₄)_{f}E_{1-f} electro-active material as defined above is preferably phosphate-based. It may exhibit an ordered or modified olivine structure.

For a positive electrode, the EAC may also be sulfur or Li₂S.

For a positive electrode, the EAC may also be a conversion-type materials such as FeS₂ or FeF₂ or FeF₃.

For a negative electrode, the EAC may be selected in the group consisting of graphitic carbons able to intercalate lithium. More details about this type of EAC may be found in Carbon 2000, 38, 1031-1041. This type of EAC typically exist in the form of powders, flakes, fibers or spheres (e.g. mesocarbon microbeads).

The EAC may also be: lithium metal; lithium alloy compositions (e.g. those described in U.S. Pat. No. 6,203,944 and in WO 00/03444); lithium titanates, generally represented by formula Li₄Ti₅O₁₂; these compounds are generally considered as “zero-strain” insertion materials, having low level of physical expansion upon taking up the mobile ions, i.e. Li+; lithium-silicon alloys, generally known as lithium silicides with high Li/Si ratios, in particular lithium silicides of formula Li_{4.4}Si and lithium-germanium alloys, including crystalline phases of formula Li_{4.4}Ge. EAC may also be composite materials based on carbonaceous material with silicon and/or silicon oxide, notably graphite carbon/silicon and graphite/silicon oxide, wherein the graphite carbon is composed of one or several carbons able to intercalate lithium.

The ECM is typically selected in the group consisting of electro-conductive carbonaceous materials and metal powders or fibers. The electron-conductive carbonaceous materials may for instance be selected in the group consisting of carbon blacks, carbon nanotubes, graphite, graphene and graphite fibers and combinations thereof. Examples of carbon blacks include ketjen black and acetylene black. The metal powders or fibers include nickel and aluminum powders or fibers.

The lithium salt (LIS) may be selected in the group consisting of LiPF₆, lithium bis(trifluoromethanesulfonyl)imide, lithium bis(fluorosulfonyl)imide, LiB(C₂O₄)₂, LiAsF₆, LiClO₄, LiBF₄, LiAlO₄, LiNO₃, LiCF₃SO₃, LiN(SO₂CF₃)₂, LiN(SO₂C₂F5)₂, LiC(SO₂CF₃)₃, LiN(SO₃CF₃)₂, LiC₄F₉SO₃, LiCF₃SO₃, LiAlCl₄, LiSb₆, LiF, LiBr, LiCl, LiOH and lithium 2-trifluoromethyl-4,5-dicyanoimidazole.

The function of the polymeric binding material (P) is to hold together the components of the composition. The polymeric binding material is usually inert. It preferably should be also chemically stable and facilitate the electronic and ionic transport. The polymeric binding material is well known in the art. Non-limitative examples of polymeric binder materials include notably, vinylidenefluoride (VDF)-based (co)polymers, styrene-butadiene rubber (SBR), styrene-ethylene-butylene-styrene (SEBS), carboxymethylcellulose (CMC), polyamideimide (PAI), poly (tetrafluoroethylene) (PTFE) and poly (acrylonitrile) (PAN) (co)polymers.

The proportion of the solid sulfide material (A) obtainable by the process according to the invention in the composition may be between 0.1 wt % to 80 wt %, based on the total weight of the composition. In particular, this proportion may be between 1.0 wt % to 60 wt %, more particularly between 5 wt % to 30 wt %. The thickness of the electrode is not particularly limited and should be adapted with respect to the energy and power required in the application. For example, the thickness of the electrode may be between 0.01 mm to 1,000 mm.

The present invention also relates to a separator comprising at least the solid sulfide material (A) obtainable by the process according to the invention.

The solid sulfide material (A) obtainable by the process according to the invention may also be used in the preparation of a separator. A separator is an ionically permeable membrane placed between the anode and the cathode of a battery. Its function is to be permeable to the lithium ions while blocking electrons and assuring the physical separation between the electrodes.

The separator of the invention typically comprises at least:
the solid sulfide material (A) obtainable by the process according to the invention;
optionally at least one polymeric binding material (P);
optionally at least one metal salt, notably a lithium salt;
optionally at least one plasticizer.

The electrode and the separator may be prepared using methods well-known to the skilled person. This usually comprises mixing the components in an appropriate solvent and removing the solvent. For instance, the electrode may be prepared by the process which comprises the following steps:
a slurry comprising the components of composition and at least one solvent is applied onto the metal substrate;
the solvent is removed.
Usual techniques known to the skilled person are the following ones: coating and calendaring, dry and wet extrusion, 3D printing, sintering of porous foam followed by impregnation. Usual techniques of preparation of the electrode and of the separator are provided in Journal of Power Sources, 2018 382, 160-175.

The electrochemical devices, notably batteries such as solid state batteries described herein, can be used for making or operating cars, computers, personal digital assistants, mobile telephones, watches, camcorders, digital cameras, thermometers, calculators, laptop BIOS, communication equipment or remote car locks, and stationary applications such as energy storage devices for power plants.

The electrochemical devices, notably batteries such as solid state batteries described herein, can notably be used in motor vehicles, bicycles operated by electric motor, robots, aircraft (for example unmanned aerial vehicles including drones), ships or stationary energy storages. Preferred are mobile devices such as are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

Should the disclosure of any patents, patent applications, and publications which are incorporated herein by reference conflict with the description of the present application to the extent that it may render a term unclear, the present description shall take precedence.

### EXAMPLES

### Characterization

The ionic conductivity can be measured on pressed (500 MPa) pellets by impedance spectroscopy.

The measurement of the ionic conductivity is generally performed on a pressed pellet. Typically, a pressed pellet is manufactured using a uniaxial or isostatic pressure. When uniaxial pressure is applied to form the pellet, a pressure above 100 MPa, preferentially above 300 Mpa, is applied for a duration of at least 30 seconds. The measurement is done under uniaxial pressure typically between 2 MPa and 200 MPa.

The pellets are sandwiched between pre-dried carbon paper electrodes used as current collector, and then loaded into air-tight sample holders. The AC impedance spectra are collected by using Biologic VMP3 device. The samples are placed in a Binder thermostatic chamber to perform the impedance measurements at different temperatures. Each spectrum is acquired after 2 hours of stabilization at the target temperature. The temperature range goes from −20° C. to 60° C. by steps of 10° C. Impedance spectroscopy is acquired in PEIS mode with an amplitude of 20 mV and a range of frequencies from 1 MHz to 1 kHz (25 points per decade and a mean of 50 measurements per frequency point). The ionic conductivity values are obtained by fitting the data into equivalent circuit models using ZView software. The slopes of the σT versus 1/T plots are calculated to determine activation energy values using Equation 1:

$$σ * T = {σ}_{0} * {e}^{- \frac{Ea}{kT}} \qquad Equation 1$$

The inventors hereby found surprisingly that solid sulfide material (A) prepared by the process according to the invention have enhanced ionic conductivity when compared to solid sulfide materials having similar composition but prepared by conventional ways such as high-temperature solid-state synthesis or mechanochemical routes.

### Production Example

In an Ar filled glovebox, Li₂S (Lorad Chemical), LiCl (Sigma-Aldrich), Na₂S (Sigma-Aldrich) and P₂S₅ (Sigma-Aldrich) were weighed and mixed in stoichiometric proportions to obtain 8 g of the desired composition of Li_{5.8} Na_{0.2}PS₅Cl. The mixture was then transferred into two 45 mL ZrO₂ jar filled with 5 mm zirconia (YSZ) balls. The ball to powder ratio was fixed at 16.5. The jar was sealed, taken out of the glovebox and placed in a Fritsch Planetary Micro Mill Pulverisette 7. Mixture was ball milled with 500 RPM rotating speed for 2 hours while employing 15 minutes breaks every 30 minutes of milling. The powder was recovered in the Ar filled glovebox (<1 ppm H₂0, <1 ppm O₂). The resulting powder was transferred into a closed SiC crucible with carbon paper box (Papyex).

The crucible was heated to 500° C. with 5° C./min heating rate in a tube furnace under N₂ atmosphere and was kept at this temperature for 12 hours. The sample was then cooled down to room temperature. It was recovered in the Ar filled glovebox and deagglomerated in a mortar.

Argyrodite phase was identified with cell parameter of 9.86 Å with presence of Li₂S impurity at 2% wt level.

### Example 1

A propylene carbonate electrolyte containing 2M LiTFSI was prepared by mixing the lithium salt and allowing dissolution at room temperature during 72 hours.

500 mg of production example was stirred with 2 mL of the electrolyte during 72 hours, then filtered onto a PVDF filter (45 μm). Powder and liquid were separately recovered, powder was dried under vacuum in a Buchi oven at 130° C. during 12 h.

Ionic conductivity at 30° C. was 1.2 mS/cm, associated with an activation energy of 0.42 eV.

### Example 2

An acetonitrile electrolyte containing 2M LiTFSI was prepared by mixing the lithium salt and allowing dissolution at room temperature during 72 hours.

500 mg of production example was stirred with 2 mL of the electrolyte during 72 hours, then filtered onto a PVDF filter (45 μm). Powder and liquid were separately recovered, powder was dried under vacuum in a Buchi oven at 130° C. during 12 h.

lonic conductivity at 30° C. was 2.47 mS/cm, associated with an activation energy of 0.41 eV.

### Comparative Example 3

500 mg of production example was stirred with 2 mL of propylene carbonate during 72 hours, then filtered onto a PVDF filter (45 μm). Powder and liquid were separately recovered, powder was dried under vacuum in a Buchi oven at 130° C. during 12 h.

lonic conductivity at 30° C. was 0.7 mS/cm, associated with an activation energy of 0.40 eV.

### Comparative Example 4

500 mg of production example was stirred with 2 mL of acetonitrile during 72 hours, then filtered onto a PVDF filter (45 μm). Powder and liquid were separately recovered, powder was dried under vacuum in a Buchi oven at 130° C. during 12 h.

Ionic conductivity at 30° C. was 1.1 mS/cm, associated with an activation energy of 0.41 eV.

It is clear that treating the production example of formula Li_{5.8} Na_{0.2}PS₅Cl with the lithium compound LiTFSI in propylene carbonate, according to the process of the present invention, rather than with pure propylene carbonate, improves the ionic conductivity of the resulting powder material. Indeed, the ionic conductivity of the resulting powder obtained in example 1 is 1.2 mS/cm when the ionic conductivity of the resulting powder obtained in comparative example 3 is 0.7 mS/cm only,

Similarly, it is clear that treating the production example of formula Li_{5.8} Na_{0.2}PS₅Cl with the lithium compound LiTFSI in acetonitrile, according to the process of the present invention, rather than with pure acetonitrile, improves the ionic conductivity of the resulting powder material. Indeed, the ionic conductivity of the resulting powder obtained in example 3 is 2.47 mS/cm when the ionic conductivity of the resulting powder obtained in comparative example 4 is 1.1 mS/cm only,

1. A process for preparing a solid sulfide material (A) of formula (I):
MₐLi_{b}P_{c}S_{d}Xₑ (I)
wherein:
X represents at least one halogen element;
a, b, c, d and e are real numbers;
a represents a number 0≤a<9;
b represents a number 0<b≤9;
2.0≤a+b≤9;
c represents a number 1.0≤c≤3.0;
d represents a number 1.0≤d≤11.0;
e represents a number 0<e≤3.0;
M is an alkali metal selected from Na, K, Rb, Cs and Fr;
comprising the steps of
(i) stirring a mixture (M1) comprising a starting material (B) of formula (II):
Mₐ₁Li_{b1}P_{c1}S_{d1}Xₑ₁ (II)
wherein:
M is an alkali metal selected from Na, K, Rb, Cs and Fr;
X represents at least one halogen element;
a1, b1, c1, d1 and e1 are real numbers;
a1 represents a number 0<a1≤9 and a<a1;
b1 represents a number 0≤b1≤ 6.0 and b1<b;
2.0≤a1+b1≤9;
c1 represents a number 1.0≤c1≤3.0;
d1 represents a number 1.0≤d≤11.0;
e1 represents a number 0<e1≤3.0;
at least one lithium compound LiY, wherein Y is a counter anion, and a solvent (S) so as to promote the reaction of the starting material (B) with the lithium compound LiY that produces the solid sulfide material (A) and at least one metal compound MY;
(ii) obtaining a mixture (M2) comprising the solid sulfide material (A), the metal compound MY, optionally unreacted lithium compound LiY and the solvent (S);
(iii) recovering the solid sulfide material (A) from the mixture (M2),
(iv) optionally submitting the solid sulfide material (A) recovered in step (iii) to a thermal treatment.

2. The process according to claim 1, wherein the starting material (B) is of formula (IIa)
Na_{7-x-y}LiₓPS_{6-y}X_{y} (IIa)
wherein 0≤x<7−y and 0<y≤3 and the solid sulfide material (A) is of formula (Ia)
Na_{7-x1-y}Liₓ₁PS_{6-y}X_{y} (Ia)
wherein 0<x1<7−y, x1>x and 0<y≤3.

3. The process according to claim 1, wherein the starting material (B) is a glass ceramic of formula (IIGa)
(1−p)[ 7/2[(1−q)Na₂S·qLi₂S]·½P₂S₅]·p[(1−r)NaX·rLiX] (IIGa);
wherein 0<p≤0.50, 0≤q<1 and 0≤r<1, and
wherein X represents at least one halogen element.

4. The process according to claim 1, wherein the starting material (B) is a glass ceramic of formula (IIGb)
(1−p)[4[(1−q)Na₂S·qLi₂S]·1P₂S₅]·p[(1−r)NaX·rLiX] (IIGb);
wherein 0<p≤0.50, 0≤q<1 and 0≤r<1, and
wherein X represents at least one halogen element.

5. The process according to claim 1, wherein the starting material (B) is a glass ceramic of formula (IIGc)
(1−p)[ 3/2[(1−q)Na₂S·qLi₂S]·½P₂S₅]·p[(1−r)NaX·rLiX] (IIGc);
wherein 0<p≤0.50, 0≤q<1 and 0≤r<1, and
wherein X represents at least one halogen element.

6. The process according to claim 1, wherein the starting material (B) is a glass ceramic of formula (IIGd)
(1−p)[ 7/2[(1−q)Na₂S·qLi₂S]· 3/2P₂S₅]·p[(1−r)NaX·rLiX] (IIGd);
wherein 0<p≤0.50, 0≤q<1 and 0≤r<1, and
wherein X represents at least one halogen element.

7. The process according to claim 1, wherein the starting material (B) is a glass ceramic of formula (IIGe)
(1−p)[[(1−q)Na₂S·qLi₂S]·P₂S₅]·p[(1−r)NaX·rLiX] (IIGe);
wherein 0<p≤0.50, 0≤q<1 and 0≤r<1, and
wherein X represents at least one halogen element.

8. The process according to claim 1, wherein the lithium compound LiY is selected from the list consisting of lithium triflate, lithium 4,5-dicyano-2-(trifluoromethyl)imidazole, lithium hexafluorophosphate, lithium bis(oxalato)borate, lithium bis(fluorosulfonyl)amide (LiFSA), Lithium bis(fluorosulfonyl)imide (LiFSI), lithium bis(trifluoromethanesulfonyl)imide (LiTFSI), lithium acetate, lithium carbonate, lithium citrate, lithium nitrate, lithium chloride, lithium bromide, lithium oxalate, lithium iodide, lithium fluoride, lithium methyl carbonate, lithium ethyl carbonate, lithium methoxide and mixtures thereof.

9. The process according to claim 1, wherein the solvent (S) is selected from the list consisting of acetonitrile, adiponitrile, glutaronitrile, acetone, ethyl acetate, ethyl propionate, diethyl ether, dimethyl carbonate, diethyl carbonate, ethyl methyl carbonate, fluoroethylene carbonate, ethylene carbonate, propylene carbonate, vinylene carbonate, DMF, NMP, DMSO, tetra(ethylene glycol) dimethyl ether, triethylene glycol dimethyl ether, diethylene glycol dimethyl ether, ethylene glycol dimethyl ether, tetrahydrofuran and mixtures thereof.

10. The process according to claim 1, wherein the starting material (B) and the solid sulfide material (A) are suspended in the solvent (S) while the lithium compound LiY and the metal compound MY are at least partially solubilized in the same.

11. A solid sulfide material (A) susceptible to be obtained by the process according to claim 1.

12. A method comprising including a solid sulfide material (A) according to claim 11 as a solid electrolyte.

13. A solid electrolyte comprising at least a solid sulfide material (A) according to claim 11.

14. An electrochemical device comprising the solid electrolyte according to claim 13.

15. An electrode comprising at least:
a metal substrate;
at least one layer made of a composition (C) in contact with the metal substrate, said composition (C) comprising:
(i) a solid sulfide material (A) according to claim 11;
(ii) at least one electro-active compound (EAC);
(iii) optionally at least one lithium ion-conducting material (LiCM) other than the solid sulfide material (A);
(iv) optionally at least one electro-conductive material (ECM);
(v) optionally a lithium salt (LIS); and
(vi) optionally at least one polymeric binding material (P).

16. A separator comprising at least:
a solid sulfide material (A) according to claim 11;
optionally at least one polymeric binding material (P);
optionally at least one metal salt, notably a lithium salt; and
optionally at least one plasticizer
